(19) United States
(12) Patent Application Publication
(10) Pub. No.: US 2005/0116078 A1
(43) Pub. Date: Jun. 2, 2005

(54) Reel clutch device and method for tape recorders

(75) Inventors: Jae-kab Seo, Suwon-si (KR); Jeong-hyeob Oh, Anyang-si (KR); Jun-young Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/963,538

(22) Filed: Oct. 14, 2004

(30) Foreign Application Priority Data
Dec. 1, 2003 (KR) 2003-86264

(51) Int. Cl. G11B 15/32

(52) U.S. Cl. 242/356.5

(57) ABSTRACT

A reel clutch device and method for tape recorders is disclosed. The reel clutch device has an elastic member mounted in the lower side of the reel disk; a reel washer mounted between the elastic member and the reel gear to be in frictional contact with the top surface of the reel gear; The reel clutch device and method further comprises a reel plate mounted to be in frictional contact with the bottom surface of the reel gear; and a reel stopper mounted on the lower side of the reel plate, and for adjusting a gap between the reel disk and the reel gear in order for adequate friction torque to occur between the reel washer and the top surface of the reel gear and the reel plate and the bottom surface of the reel gear.

This application claims benefit under 35 U.S.C.§ 119(a) from Korean Patent Application No. 2003-86264, filed on Dec. 1, 2003, the entire contents of which is incorporated herein by reference.

### BACKGROUND OF THE INVENTION

1. Field of the Invention

The present invention relates to a reel disk assembly for tape recorders that plays a tape cassette. More particularly, the present invention relates to a reel clutch device and method for tape recorders which transfers the rotary torque of a reel gear to a reel disk.

2. Description of the Related Art

Tape recorders are devices for recording information on a recording medium such as magnetic tapes and reproducing the recorded information. Examples of tape recorders are video cassette tape recorders(VCRs), camcorders, and so on.

Referring to FIG. 1, a tape recorder has a main deck 2 on which a head drum 1 is rotatably mounted, a sub-deck 3 mounted on the main deck 2 and able to be loaded and unloaded on the main deck 2, a pair of reel disk assemblies 20 rotatably mounted on the sub-deck 3 for driving the tape reel of a tape cassette (not shown), and a power transmission unit 10 for selectively transmitting the power of a capstan motor (not shown) mounted on the main deck 2 to one of the pair of reel disk assemblies 20.

The pair of reel disk assemblies 20 is provided with a supply reel disk assembly 22 for supplying magnetic tape from a tape cassette and a take-up reel disk assembly 21 for winding up the supplied magnetic tape.

The power transmission unit 10 has a capstan gear 15 meshed with a shaft gear 5 of the capstan motor, a timing belt 11 for transmitting the power of the capstan gear 15 to a pulley gear 12, and an idle gear 14 meshed with the pulley gear 12 and selectively coupled by a rotation lever 13 with one of the pair of reel disk assemblies 21 and 22 to transmit power, with the rotation lever 13 rotating about the shaft of the pulley gear depending upon the rotation direction of the pulley gear 12.

According to the described structure, the power of the capstan motor rotating at a high speed is transmitted to one of the pair of reel disk assemblies 21 and 22 via the power transmission unit 10 depending upon an operation mode, to thereby play the magnetic tape in a forward or a reverse direction. The pair of reel disk assemblies 20 has a reel clutch device for producing a proper torque to adjust the traveling speed of the magnetic tape based on the tension of the magnetic tape.

FIG. 2 is a cross-sectioned view showing a conventional magnet reel clutch device for tape recorders, for example, the described reel clutch device. Referring to FIG. 2, the magnet reel clutch device includes a reel gear 32 and a reel disk 31 assembled stacked on the deck (not shown) of the tape recorder, an iron-plate base 35 and an iron plate 33 which are mounted in the reel gear 32 and the reel disk 31 are opposite each other, and a magnet 34 mounted between the iron base 35 and the iron plate 33.

In the reel clutch device having the described structure, when the power is transmitted from the capstan motor via the reel gear 32, an adequate torque is transmitted to the reel disk 31 by a magnetic force which is generated between the iron plate 33 and the magnet 34.

However, in the described reel clutch device, the iron-plate base 35 supporting the magnet 34 is press-fitted to the reel gear 32 in an inserting manner, and the iron plate 33 is press-fitted to the reel disk 31 in an outserting manner, which results in problems with assembling the device. Further, the magnet is expensive.

FIG. 3 is an exploded perspective view showing a conventional felt reel clutch device 20 for tape recorders. Specifically, FIG. 3 is a view for showing another conventional reel disk assembly 20 including a felt reel clutch device. Referring to FIG. 3, the reel disk assembly 20 has an upper disk 41 having the tape reel of a tape cassette fitted thereto and seated thereon, a lower disk 45 fitted from the bottom of and coupled with the upper disk 41, and a reel gear 42, a spring 43, and a contact piece 44 which are installed between the respective disks 41 and 45 to provide a friction force. Felt piece 46 provided on the lower disk 45 contacts with the bottom surface of the reel gear 42 so that torque is transmitted by friction. Further, the transmitted torque is properly adjusted by the force of the spring 43. In the described structure, the idle gear 14 of FIG. I is coupled with and transmits the power of the capstan motor to the reel gear 42, and the power is transmitted to the upper disk 41 through the lower disk 45 by the friction between the felt 46 and the reel gear 42. Therefore, an adequate torque is transmitted to the upper disk 41 through the lower disk 45 depending upon the tension of the magnetic tape. Further, the tape reel of a tape cassette seated on the upper disk 41 turns based on the torque transmitted to the upper disk 41 so that the magnetic tape is wound.

The reel clutch device using felt as described has an advantage of having a low manufacturing cost due to a simple assembly and low supply cost compared to the magnet reel clutch device. However, the reel clutch device using the felt has less functional reliability due to variations of transmission torque resulting from the characteristics of the felt which are affected by temperature and humidity. In particular, the felt reel clutch device has a problem in transmitting a constant torque since the torque rapidly increases in high humidity and goes through severe variations in its magnitude at low temperatures.

### SUMMARY OF THE INVENTION

The present invention has been developed in order to solve the above drawbacks associated with the conventional arrangement. An aspect of the present invention is to provide a reel clutch device and method for tape recorders which can be manufactured at low cost and transmit a constant torque regardless of variations of ambient environment.

The foregoing and other objects and advantages are substantially realized by providing a reel clutch device and method for tape recorders mounted in a reel disk assembly to transmit rotary torque of a reel gear to a reel disk, the reel disk assembly being mounted on a deck of each of the tape recorders and having the reel gear and the reel disk, comprising an elastic member mounted in the lower side of the reel disk; a reel washer mounted between the elastic member and the reel gear to be in frictional contact with the top surface of the reel gear; a reel plate mounted to be in frictional contact with the bottom surface of the reel gear; and a reel stopper mounted on the lower side of the reel plate, and for adjusting a gap between the reel disk and the reel gear in order for adequate friction torque to occur between the reel washer and the top surface of the reel gear and the reel plate and the bottom surface of the reel gear.

The friction torque is transmitted to the reel disk by the reel stopper. Further, the reel washer has an opening in a hexagonal shape, and a corresponding part of the reel stopper to which the reel washer is fitted is formed in a hexagon-shaped shaft. Furthermore, the reel plate has an opening in a hexagonal shape, and a corresponding part of the reel stopper to which the reel plate is fitted is formed in a hexagon-shaped protrusion.

In the reel clutch device and method for tape recorders according to one aspect of the present invention, the reel gear has a serration formed on at least one side thereof with which the reel washer and the reel plate are in contact. The serration is formed with plural concentric circles having a certain interval between each other. The reel washer and the reel plate are preferably each formed of any one of iron, somaraito, and Teflon. Lubricant is applied between the reel washer, reel plate, and reel gear.

The elastic member is a cone-shaped coil spring.

As described above, the reel clutch device and method for tape recorders according to the present invention can be manufactured at low manufacturing cost due to low supplies cost and less assembly work.

Furthermore, the reel clutch device and method according to the present invention can transmit a constant torque regardless of variations of ambient environment.

### BRIEF DESCRIPTION OF THE DRAWINGS

The above aspects and features of the present invention will be more apparent by describing certain embodiments of the present invention with reference to the accompanying drawings, in which:

FIG. 1 is a plan view for schematically showing a conventional tape recorder;

FIG. 2 is a cross-sectioned view showing a conventional magnet reel clutch device for tape recorders;

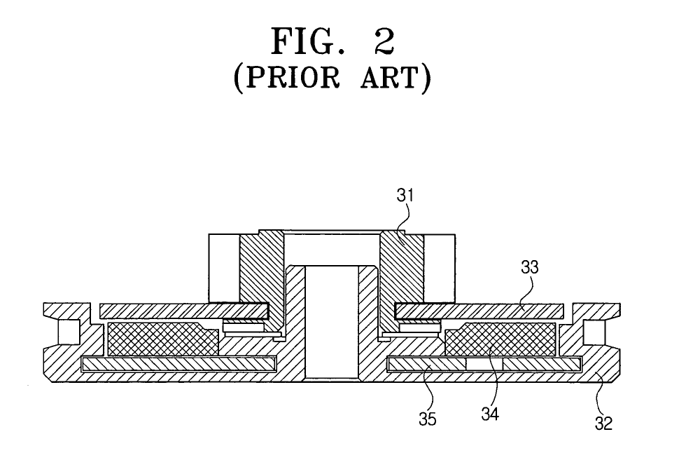

FIG. 3 is an exploded perspective view showing a conventional felt reel clutch device for tape recorders;

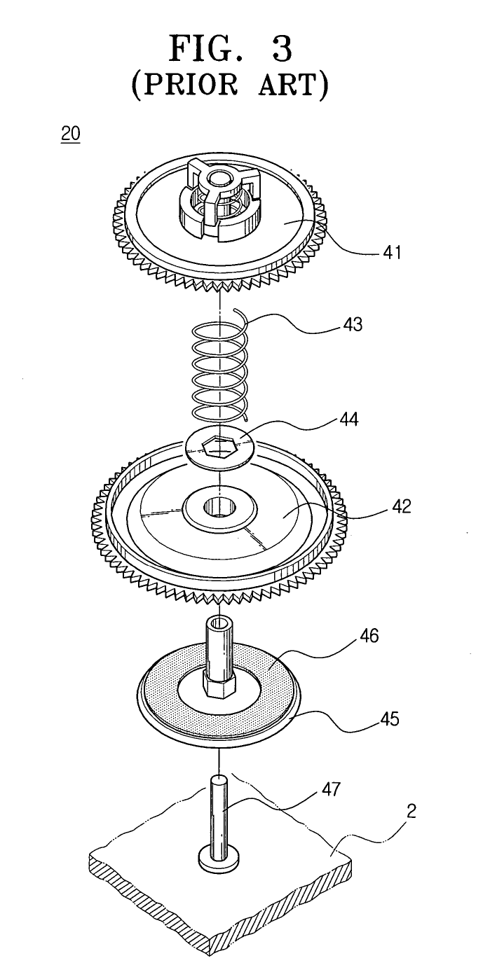

FIG. 4 is a cross-sectioned view showing a reel clutch device for tape recorders according to an embodiment of the present invention;

FIG. 5 is an enlarged cross-sectioned view for showing a portion A of FIG. 4; and

FIG. 6 is an exploded perspective view showing the reel clutch device for tape recorders shown in FIG. 4.

In the drawings, it should be noted that the same or similar elements are denoted by the same reference numerals even though they are depicted in different drawings.

### DETAILED DESCRIPTION OF THE PREFERRED EMBODIMENTS

Embodiments of the present invention will be described in greater detail with reference to the accompanying drawings.

In the following description, the same drawing reference numerals are used for the same elements in different drawings. Examples are used to describe embodiments of the present invention. Thus, it should be apparent that the present invention can be performed without the examples shown without departing from the scope of the invention. Also, well-known functions or constructions are not described in detail for conciseness.

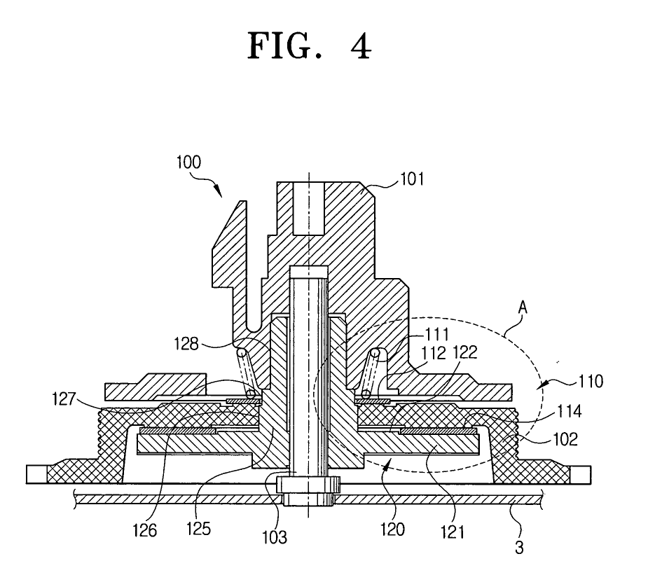

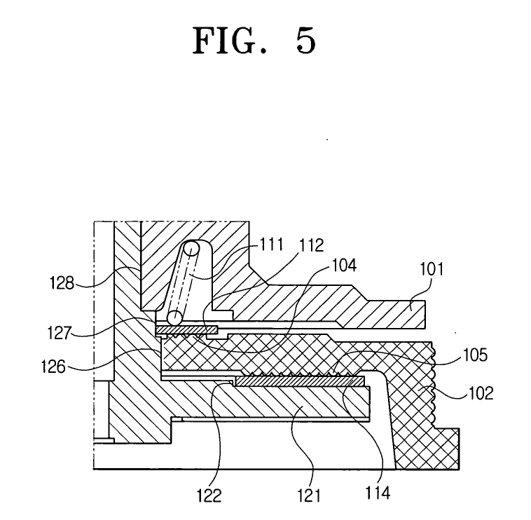

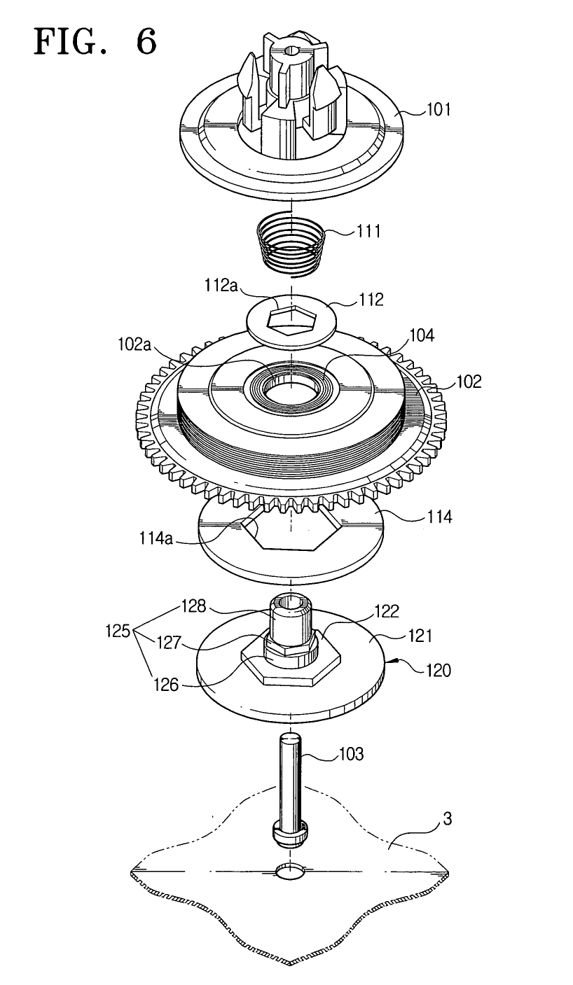

FIG. 4 is a cross-sectioned view showing a reel disk assembly including a reel clutch device for tape recorders according to an embodiment of the present embodiment, FIG. 5 is an enlarged cross-sectioned view showing a portion A of FIG. 4, and FIG. 6 is an exploded perspective view showing the reel clutch device for tape recorders shown in FIG. 4.

Referring to FIG. 4 to FIG. 6, a reel clutch device 110 for tape recorders according to an embodiment of the present invention has an elastic member 111, a reel washer 112, a reel plate 114, first and second serrations 104 and 105 formed on the upper and lower sides of the reel gear 102, and a reel stopper 120.

The elastic member 111 is mounted in the lower side of the reel disk 101, and applies a constant pressure to the reel washer 112 against the upper surface of the reel gear 102. A cone-shaped coil spring is used for the elastic member 111 in an embodiment of the present invention.

The reel washer 112 is interposed between the reel gear 102 and the elastic member 111, and assembled on the reel stopper 120, in frictional contact with the upper surface of the reel gear 102. The opening 112a of the reel washer 112 is formed in a polygonal shape such as a rectangular shape, a hexagonal shape, and a portion 127 of the reel stopper 120 on which the reel washer 112 is assembled is shaped in relation to the opening 112a of the reel washer 112. Therefore, if the opening 112a of the reel washer 112 is shaped in hexagon as shown in the present embodiment, the portion 127 of the reel stopper to be assembled is shaped as a hexagonal shaft.

The reel plate 114 is located between the bottom of the reel gear 102 and the reel stopper 120, and assembled to be in frictional contact with the bottom of the reel gear 102. The opening 114a of the reel plate 114 is formed in a polygonal shape such as a rectangular shape, a hexagonal shape, and a portion 122 of the reel stopper 120 on which the reel plate 114 is assembled is shaped in relation to the opening 114a of the reel plate 114. Therefore, if the opening 114a of the reel plate 114 is formed in the hexagonal shape, a hexagonal projection portion 122 is formed on the base portion 121 of the reel stopper 120 to be assembled.

The reel washer 112 and the reel plate 114 can be formed of, for example, iron plate, somaraito or teflon. Since somaraito and teflon have a lubrication property, extra lubricant may not be required. If substances such as an iron plate are used, lubricant such as oil is applied on the surface of the iron plate which is in contact with the reel gear 102, to thereby reduce abrasion and friction torque variations that can occur upon friction.

Serrations are provided on the reel gear 102 to reduce variations of the torque transmitted by friction. The first serration 104 is formed on the top surface of the reel gear 102 in frictional contact with the reel washer 112, and the second serration is formed on the bottom surface of the reel gear 102 in frictional contact with the reel plate 114. As shown in FIG. 5 and FIG. 6, the first and second serrations 104 and 105 have plural protrusions formed in the concentric circles about the rotation shaft of the reel gear 102.

The reel stopper 120 is assembled on the bottom of the reel plate 114, and force-fitted to the reel disk 101 to rotate about the reel shaft 103 fixed to the sub-deck 3 integrally with the reel disk 101. The reel stopper 120 includes the base part 121 and a shaft part 125, and the base portion 121 has the protrusion portion 122 to which the reel plate 114 is fitted. Further, the shaft part 125 has a reel gear fitting portion 126 to which the reel gear 102 is rotatably assembled, a reel washer fitting portion 127 to which the reel washer 112 is fixed, and a reel disk fitting portion 128 to which the reel disk 101 is fitted. Further, the assembling gap between the reel stopper 120 and the reel disk 101 and the elastic force of the elastic member 111 determine the friction torque occurring between the reel washer 112 and the top surface of the reel gear 102 and between the reel plate 114 and the bottom surface of the reel gear 102. Thus, the feature of the elastic member 111 and the assembling gap between the reel stopper 120 and the reel disk 101 are determined in order for the power of the capstan motor transmitted to the reel gear 102 be properly transmitted to the reel disk 101.

Descriptions will now be made on the exemplary assembling order of the reel disk assembly including the reel clutch device for tape recorders which has the previously described structure.

First, the reel plate 114 is fitted to the base part 121 of the reel stopper 120. At this time, the reel plate 114 is precisely fitted to the opening 114a to the protrusion portion 122 of the reel stopper base part 121. Next, the reel gear 102 is fitted to the shaft part 125 of the reel stopper 120. Thus, the reel gear 102 is fitted to the reel gear fitting portion 126 of the reel stopper 120 through the opening 102a. Next, the reel washer 112 is inserted into the shaft part 125 of the reel stopper 120 through the opening 112a so as to be in contact with the first serration 104 of the reel gear 102. At this time, the reel washer 112 is precisely fitted to the reel washer fitting portion 127 of the reel stopper 120 through the opening 112a. Next, the elastic member 111 is inserted into the shaft part 125 of the reel stopper 120, and the reel disk 101 is press-fitted to the reel disk fitting portion 128 of the reel stopper 120. For the complete assembly, the fully assembled reel disk assembly 100 is inserted into the reel shaft 103 fixed to the sub-deck 3.

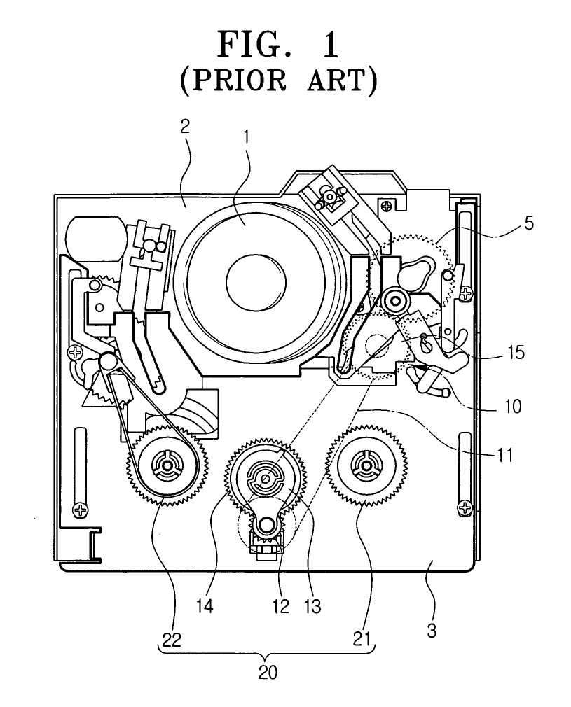

Descriptions will now be made on operations of the reel clutch device for tape recorders according to one exemplary embodiment of the present invention with reference to FIG. 1, and FIG. 4 to FIG. 6.

The power of the capstan motor is transmitted through the power transmission unit 10 (refer to FIG. 10) so that the reel gear 102 rotates. Since the reel gear 102 is assembled to the reel gear fitting portion 126 of the reel stopper 120 by loose-fitting, the power of the reel gear 102 is not transmitted to the reel stopper 120 directly even though the reel gear 102 rotates. That is, the reel gear 102 rotates in friction contact of the first and second serrations 104 and 105 thereof with the reel washer 112 and the reel plate 114 respectively. Since the reel washer 112 and the reel plate 114 press the reel gear 102 by the elastic member 111, the reel washer 112 and the reel plate 114 rotate with the reel gear 102 by a friction force between the first serration 104 and the reel washer 112 and a friction force between the second serration 105 and the reel plate 114. However, since the reel washer 112 and the reel plate 114 are fixed to the reel stopper 120 by the hexagonal reel washer fitting portion 127 and the protrusion part 122, the reel stopper 120 rotates as the reel washer 112 and the reel plate 114 rotate. That is, the power of the reel gear 102 changes to a friction torque on the reel washer 112 and the reel plate 114 to rotate the reel stopper 120. Thus, the reel disk 101 coupled in one body with the reel stopper 120 rotates, which causes the magnet tape to be wound on the tape reel seated on the reel disk 101. At this time, the friction torque transmitted by the friction force between the first and second serrations 104 and 105 of the reel gear 102, the reel washer 112, and the reel plate 114 is adequately adjusted depending upon the tension of the magnet tape.

As described above, the reel clutch device for tape recorders has an advantage of having a low supply cost since the magnets are not used, and of easy assembly since it can be assembled with the reel plate, reel gear, reel washer, elastic member, and reel disk inserted in order of the reel stopper. Further, the reel clutch device can minimize variations of the friction torque transmitted due to the changes of ambient environment such as temperature, humidity, and so on, since the members for friction are formed of iron, somaraito, Teflon, and the like, which are robust against ambient environment changes.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A reel clutch device for tape recorders mounted in a reel disk assembly to transmit rotary torque of a reel gear to a reel disk, the reel disk assembly being mounted on a deck of each of the tape recorders and having the reel gear and the reel disk, comprising:
an elastic member mounted in the lower side of the reel disk;
a reel washer mounted between the elastic member and the reel gear and in frictional contact with the top surface of the reel gear;
a reel plate mounted to be in frictional contact with the bottom surface of the reel gear; and
a reel stopper mounted on the lower side of the reel plate for adjusting a gap between the reel disk and the reel gear in order for adequate friction torque to occur between the reel washer and the top surface of the reel gear and the reel plate and the bottom surface of the reel gear.

2. The reel clutch device as claimed in claim 1, wherein the friction torque is transmitted to the reel disk by the reel stopper.

3. The reel clutch device as claimed in claim 2, wherein the reel washer has an opening comprising a hexagonal shape, and a corresponding part of the reel stopper to which the reel washer is fitted comprises a hexagon-shaped shaft.

4. The reel clutch device as claimed in claim 2, wherein the reel plate has an opening comprising a hexagonal shape, and a corresponding part of the reel stopper to which the reel plate is fitted is formed comprises a hexagon-shaped protrusion.

5. The reel clutch device as claimed in claim 1, wherein the reel gear has a serration formed on at least one side thereof with which the reel washer and the reel plate are in contact.

6. The reel clutch device as claimed in claim 5, wherein the serration is formed with a plurality of concentric circles having a predetermined interval between each one of the plurality of concentric circles.

7. The reel clutch device as claimed in claim 5, wherein the reel washer and the reel plate comprises at least one of iron, somaraito, and Teflon.

8. The reel clutch device as claimed in claim 5, wherein lubricant is applied between the reel washer, reel plate, and reel gear.

9. The reel clutch device as claimed in claim 1, wherein the elastic member comprises a cone-shaped coil spring.

10. A method for transmitting rotary torque of a reel gear to a reel disk reel clutch device for tape recorders mounted in a reel disk assembly, the method comprising:
mounting an elastic member in the lower side of the reel disk;
mounting a reel washer between an elastic member and the reel gear, and placing the reel washer in frictional contact with the top surface of the reel gear;
mounting a reel plate to be in frictional contact with a bottom surface of the reel gear; and
mounting a reel stopper on the lower side of the reel plate in order to adjust a gap between the reel disk and the reel gear and provide adequate friction torque to occur between the reel washer and the top surface of the reel gear and the reel plate and the bottom surface of the reel gear.

11. The method of claim 10 further comprising:
transmitting the friction torque to the reel disk via the reel stopper.

12. The method of claim 10, wherein the reel washer has an opening comprising a hexagonal shape, and a corresponding part of the reel stopper to which the reel washer is fitted comprises a hexagon-shaped shaft.

13. The method of claim 10, wherein the reel plate has an opening comprising a hexagonal shape, and a corresponding part of the reel stopper to which the reel plate is fitted is formed comprises a hexagon-shaped protrusion.

14. The method of claim 10, wherein the reel gear has a serration formed on at least one side thereof with which the reel washer and the reel plate are in contact.

15. The method of claim 14, further comprising:
forming the serration with a plurality of concentric circles having a predetermined interval between each one of the plurality of concentric circles.

16. The method of claim 14, wherein the reel washer and the reel plate comprises at least one of iron, somaraito, and Teflon.

17. The method of claim 14, further comprising:
applying lubricant between the reel washer, reel plate, and reel gear.

18. The method of claim 10, wherein the elastic member comprises a cone-shaped coil spring.
